(19) United States
(12) Patent Application Publication
(10) Pub. No.: US 2006/0096764 A1
(43) Pub. Date: May 11, 2006

(54) Machine for laying sod

(76) Inventors: Gerardus J. Brouwer, Keswick (CA); Robert Milwain, Keswick (CA)

Correspondence Address: BERESKIN AND PARR, 40 KING STREET WEST, BOX 401, TORONTO, ON, M5H 3Y2, CA

(21) Appl. No.: 11/230,557

(22) Filed: Sep. 21, 2005

Related U.S. Application Data
(60) Provisional application No. 60/612,162, filed on Sep. 23, 2004.

(51) Int. Cl. A01B 45/04

(52) U.S. Cl. 172/19

(57) ABSTRACT

A machine to facilitate sod laying, having a pair of tracks spaced apart to define an open-ended space between them, with a low platform over each track and a forklift supporting a pallet load of sod or other materials located in the space between the tracks. Persons laying sod can stand on the platforms and can without obstruction place sod or other materials from the pallet on the forklift onto the ground. The forklift carriage has wheels which are guided by a pair of channels having downwardly and rearwardly extending lower portions, so that when the wheels enter the lower portions, the fork tines will be tilted downwardly and forwardly without needing a costly tilt cylinder.

### PRIOR APPLICATION

This application claims the benefit of U.S. Provisional Application Ser. No. 60/612,162, filed Sep. 23, 2004 entitled “MACHINE FOR LAYING SOD”.

### FIELD OF THE INVENTION

This invention relates to a sod laying machine. The machine of the invention can also be used for laying other landscaping products, and other types of products.

### BACKGROUND OF THE INVENTION

It has been common practice for approximately the last half century to cut sod from a field of sod, stack the cut sod on a pallet (usually in the form of rolls or slabs), and then to transport the pallet (usually by truck) to a site where the sod is to be laid. The steps involved in the foregoing procedure have been largely automated, and improved efficiencies in cutting, stacking and handling the sod are continually being developed.

However the task of laying the sod on ground to be sodded remains almost entirely an intensive manual labor task. Various machines have been developed for laying sod, in an attempt to automate the process, but so far as is known, no one has been able to develop a successful machine for laying small rolls and slabs of sod. All of the sod laying machines introduced to date have been too complicated, or too expensive, or have suffered from other major limitations which made them unacceptable in the marketplace. For example, in many instances the machines were too large to travel through the narrow passageways which are often the only way to access yards and other locations where sod is to be laid.

### SUMMARY OF THE INVENTION

It is therefore an object of present invention, in one of its aspects, to provide a machine which is relatively simple and inexpensive, and which facilitates the laying of sod and reduces the time spent in manually laying the sod. In one aspect the invention provides a vehicle for facilitating the laying of a landscaping material on the ground, said vehicle comprising: (a) first and second movable supports for supporting said vehicle on the ground and for driving said vehicle over the ground, said movable supports being spaced apart laterally to leave an open-ended space there between, (b) a forklift located in said space and having fork tines to support a pallet laden with said landscaping material, and (c) a pair of platforms, one located over each of said movable supports and each adapted to support a person such that said person while on said platform can reach landscaping material on said pallet and can place said landscaping material on the ground.

Further objects and advantages of the invention will appear from the following description, taken together with the accompanying drawings.

### BRIEF DESCRIPTION OF THE DRAWINGS

In the drawings:

FIG. 1 is a perspective view of a machine according to the invention;

FIG. 2 is another perspective view of the machine of FIG. 1, with a pallet in place thereon, the pallet being close to the ground;

FIG. 3 is a perspective view similar to FIG. 2 but with the pallet raised;

FIG. 4 is an end view of the machine of FIG. 1 with the pallet in position thereon;

FIG. 5 is a side view of the machine of FIG. 1;

FIG. 6 is a perspective view from above of the controls for the machine of FIG. 1;

FIG. 7 is an end view of the machine of FIG. 1;

FIG. 8 is a diagrammatic side view of a portion of a preferred forklift mechanism for the FIG. 1 machine; and

FIG. 9 is a view similar to that of FIG. 8 but showing the forklift mechanism in position to pick up a pallet.

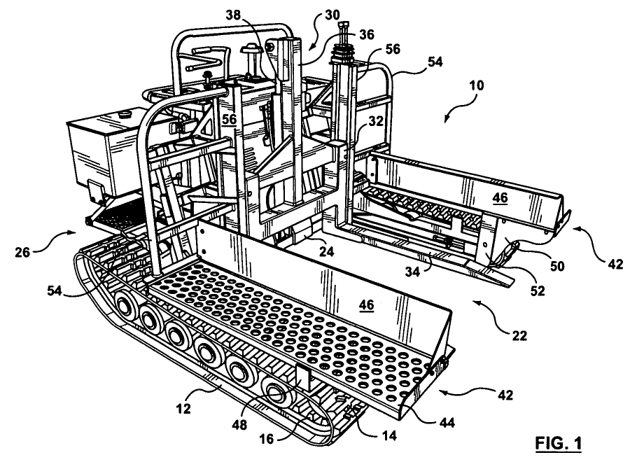

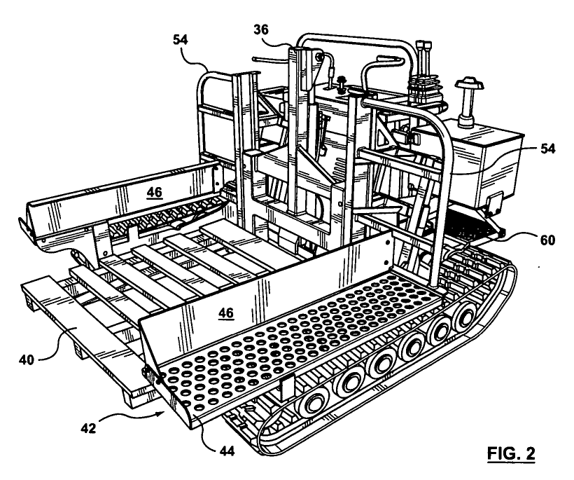

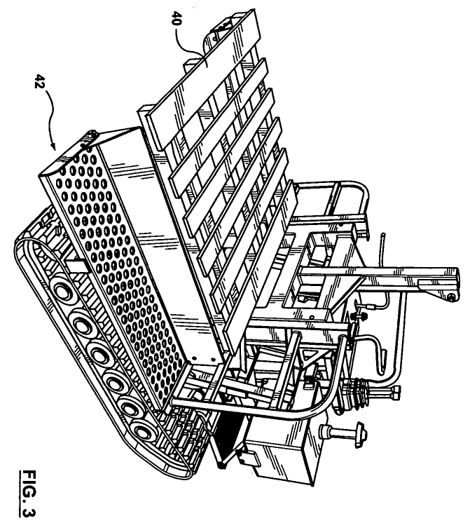

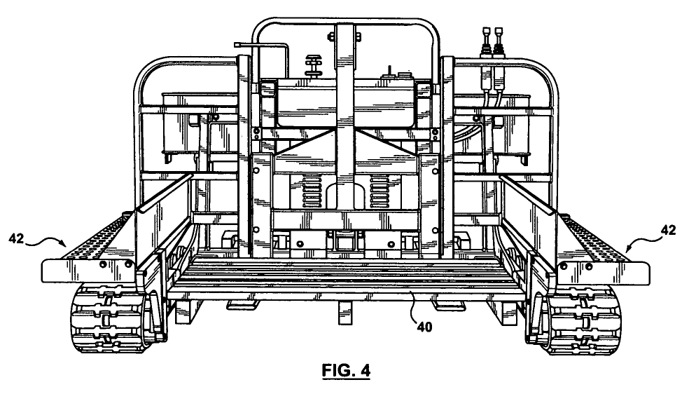

### DETAILED DESCRIPTION OF THE INVENTION

As shown in the drawings, the machine 10 according to the invention, is preferably a tracked vehicle, having a pair of relatively wide tracks 12. The tracks 12 are of conventional design, typically being formed of a rubberized material with short projecting ridges 14 or knobs for traction, and are supported on a conventional support structure 16 at each side of the machine 10. The track support structure 16 includes the usual guide wheels 18 and sprockets 20 to guide and drive the tracks 12, and a track support frame 21. The tracks 12 are relatively wide, so as to apply a low pressure to the ground over which they travel, and are spaced laterally apart, leaving an open-ended space 22 between them. The support structures 16 for each track 12 are joined by a cross-frame structure 24 at one end 26 of the machine 10. Any suitable track design can be used.

Located between the tracks 12, in the open-ended space 22, is a conventional forklift 30. Forklift 30 typically has a fork 32 with a pair of tines 34, which can be raised and lowered on a mast 36, using any desired conventional elevating mechanism. For example, since only a fairly small lift is required for the tines 34, a simple piston and cylinder mechanism 38 can be used to raise and lower the fork.

The fork 32 can be used to engage and support a pallet 40 on which sod (not shown) is stacked. The sod can be stacked on pallet 40 in the form of folded or unfolded slabs, or in rolls, as desired.

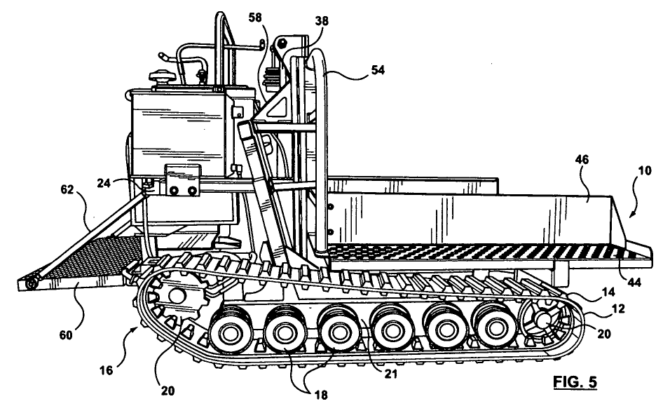

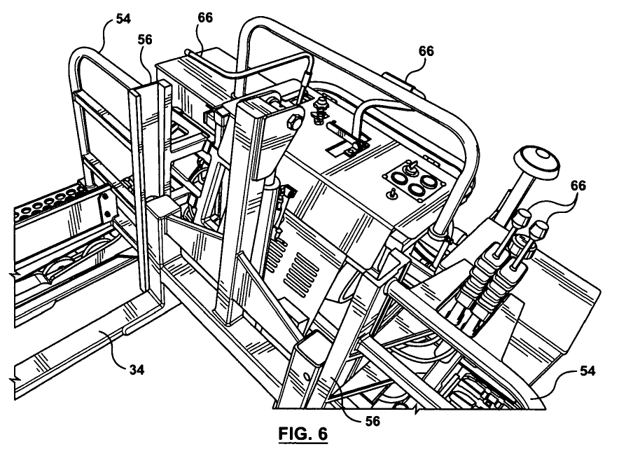

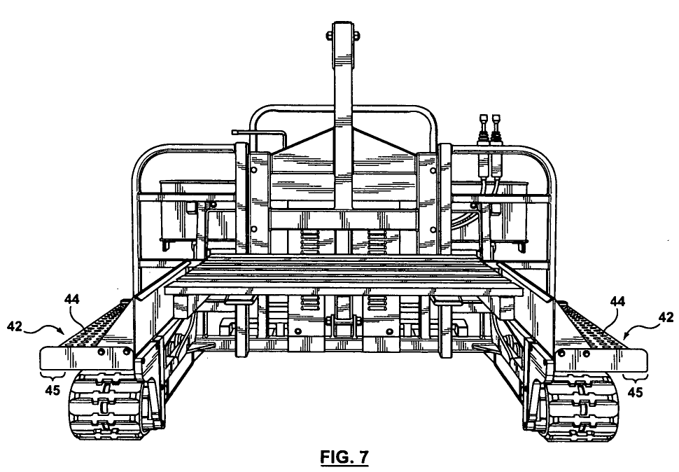

Located on each side of the open-ended space 22, over each track 12, is a platform 42. The two platforms 42, one on each side of the machine 10, are mirror images of each other. Each platform includes a horizontal perforated metal foot plate 44 which extends lengthwise of the machine for approximately the length of the pallet, and also extends laterally outwardly slightly beyond each track 12, as best shown at 45 in FIG. 7. Each platform 42 also includes a vertical upwardly extending guard plate 46 at the inner edge of the foot plate 44, to prevent a person standing on the foot plate from inadvertently stepping through the narrow space between the inner edge of the foot plate 44 and the sod laden pallet 40. Each platform 42 is supported adjacent the open end of the space 22 by a laterally extending support beam 48 attached to a vertical downwardly extending flange 50. The flange 50 is connected, e.g. by a screw 52, to the track support frame 21. At the other end of the machine 10, the platforms 42 are connected to a pair of railing structures 54, one on each side of the machine 10. The railing structures 54 are connected to two laterally spaced posts 56 which form vertical guides for the fork 32. The posts 56 are connected to the cross-frame structure 24 by a set of beams 58 (FIG. 5).

The driver of the machine 10 stands on a platform 60 which extends from the end of the machine opposite from the open-ended space 22. The platform 60 may be connected very simply to the machine 10, e.g. by a pair of support bars 62 connected between the cross-frame support structure 24 and the outer end of the platform 60.

The machine 10 includes a motor and hydraulic pump (hidden from view by covers) to move the machine and operate the forklift 30. Conventional controls 66 are provided to operate the machine 10, by driving each track 12 forwardly or rearwardly at desired speed to propel the machine and to steer it, and also to control the forklift 30. Since the machine 10 normally operates at low speed, with numerous stops and starts, it preferably has a conventional hydrostatic or other automatic transmission.

In use, the fork 32 will support a pallet 40, the pallet being loaded with sod. Because the machine 10 is small, it can be driven into yards and other restricted spaces which cannot be accessed by larger machines. Even on wet ground, the wide tracks will cause minimal damage.

A sod laying person will stand on each platform 42 at each side of the machine 10, and as the machine 10 travels over the ground on which sod is to be laid, the sod laying persons will be able to reach sod pieces stacked on the pallet 40 and will be able to throw the sod pieces onto the ground on each side of the machine 10, or in front of the machine (the front being the pallet). After the sod laying persons have thrown an appropriate number of sod pieces onto the ground from each side of the machine 10, these persons can easily step off the machine 10 (since the platforms 42 are low) and can use rakes or other long handled tools to place the pieces of sod in the exact locations desired. In many cases this task can also be performed by other people already on the ground. However, if the persons on the platforms 42 have stepped off them to adjust the location of the sod pieces on the ground, then they can easily step back on the platforms 42 to lay further pieces of sod as the machine 10 moves through the area where sod is being laid.

When a pallet 40 full of sod is initially placed on the machine 10, and when sod is being laid, the pallet 40 will normally be in a low position, close to the ground, so that the top pieces of sod stacked on the pallet 40 are readily accessible to the sod laying persons standing on the platforms 42 on each side of the pallet 40. As the sod at the top of the pallet 40 is laid, the fork 32 and hence the pallet 40 will be raised, to bring the new and lower top of the sod stacked on the pallet within easy reach of the persons standing on the platforms 42.

Because the machine 10 provides a platform 42 on each side of the pallet 40, with ready access to the sod stacked on the pallet, and because the platforms 42 are low (close to the ground) and access from them to the ground in a forward or sideways direction is not obstructed, the machine 10 makes the task of lifting sod pieces off the pallet 40 and placing them in the desired locations on the ground very simple and enables this task to be performed rapidly and efficiently by persons standing on the platforms 42. In addition, because the machine 10 is small and lightweight, it can easily pass through small passageways and any damage which it may do to earth which has been prepared to receive sod will usually be minimal.

Because the platforms 42 are over the tracks 12, and are next to the sod to be laid (stored on pallet 40), and because the platforms 42 extend laterally outwardly beyond the tracks 12, access to the ground by the persons standing on the platforms 42 is maximized, and interference with this access by the tracks 12 is minimized.

It will be understood that various changes can be made in the machine described. For example, while a tracked vehicle is preferred because of its minimal impact on soft earth, a wheeled vehicle could also be used, provided that the tires are relatively wide and low and do not concentrate pressure on the ground. In addition, while the machine 10 has been described for use in laying sod, it can be used to lay other landscaping products, e.g. other plant materials, or even paving stones, or other non-landscaping products.

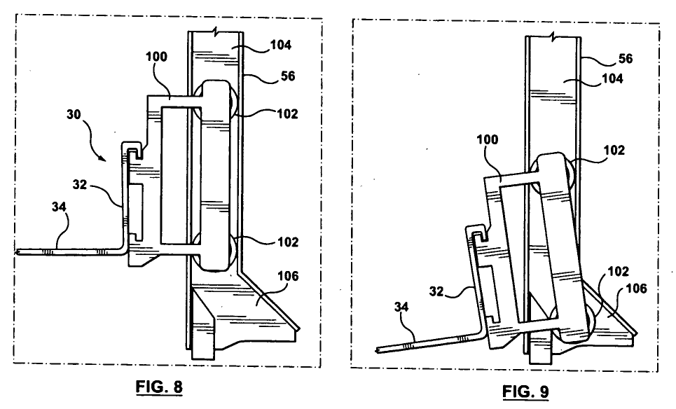

While a conventional forklift mechanism 30 can be used, a forklift mechanism such as that shown in FIGS. 8 and 9 is preferred. In the forklift mechanism there shown, the fork 32 is carried on a fork carriage 100 having four guide wheels 102 (only two are shown) which ride in the channels formed by vertical guideposts 56. These channels, indicated at 104 in FIGS. 8 and 9, have a downwardly and rearwardly extending bottom portion 106. Thus, as the forks are lowered, the lower fork carriage wheel 102 will move into the downwardly and rearwardly extending channel portion 106 and will move to the rear, as shown in FIG. 9. This rearward movement of lower wheel 102 tilts the fork tines 34 downwardly and forwardly, thus facilitating pick up of a pallet laden with sod. Since no tilt cylinder or associated mechanism is required for the downward tilt described, the cost of the tilt mechanism is kept very low.

It will be appreciated that various changes can be made in the machine as described, and all such changes are intended to be included in the invention.

1. A vehicle for facilitating the laying of a landscaping material on the ground, said vehicle comprising:
a) First and second movable supports for supporting said vehicle on the ground and for driving said vehicle over the ground, said movable supports being spaced apart laterally to leave an open-ended space there between,
b) A forklift located in said space and having fork tines to support a pallet laden with said landscaping material,
c) A pair of platforms, one located over each of said movable supports and each adapted to support a person such that said person while on said platform can reach landscaping material on said pallet and can place said landscaping material on the ground.

2. A machine according to claim 1 wherein said movable supports comprise a pair of tracks, one on each side of said machine.

3. A machine according to claim 2 wherein said platforms each extend laterally outwardly beyond the said track over which it is located.

4. A machine according to claim 3 wherein there is no obstruction between the outer edge of each platform and the ground.

5. A machine according to claim 4 wherein there is a cross-frame structure joining said tracks at an end thereof remote from said open end of said space, said machine including a motor located on said cross-frame structure, and controls for said motor, so that said machine is self-propelled.

6. A machine according to claim 1 wherein said forklift comprises a fork carriage supporting said fork tines, said fork tines normally extending forwardly, said fork carriage having wheels, and a pair of spaced apart substantially upright guides adapted to receive said wheels to guide said fork carriage for movement of said fork carriage in a substantially up and down direction, said guides having lower portions which extend in a downwardly and rearwardly direction so that when said wheels enter said lower portion, said fork carriage and hence said fork tines tilt in a downwardly and forwardly extending direction.

7. A forklift comprising a fork carriage, a set of fork tines mounted on said fork carriage and extending in a frontward direction, said fork carriage having wheels, a pair of substantially upright spaced apart guides having openings therein to guide said wheels in a substantially up and down direction, said guides each having a lower portion extending in a downwardly and rearwardly direction so that when wheels of said fork carriage enter said lower portion, said fork carriage and hence said tines will be tilted in a downward and frontward direction.
